(19) United States
(12) Patent Application Publication
(10) Pub. No.: US 2025/0096970 A1
(43) Pub. Date: Mar. 20, 2025

(54) COMMUNICATING BASED ON AN SSB BURST CONFIGURATION

(71) Applicant: Lenovo (Singapore) Pte. Ltd., New Tech Park (SG)

(72) Inventors: Hyejung Jung, Northbrook, IL (US); Vijay Nangia, Woodridge, IL (US); Majid Ghanbarinejad, Chicago, IL (US)

(21) Appl. No.: 18/728,839

(22) PCT Filed: Jan. 14, 2023
(86) PCT No.: PCT/IB2023/050344

§ 371 Date: Jul. 12, 2024

Related U.S. Application Data
(60) Provisional application No. 63/299,767, filed on Jan. 14, 2022.

(51) Int. Cl. H04L 5/00; H04W 56/00; H04W 74/0833

(52) U.S. Cl. CPC H04L 5/0048; H04W 56/0015; H04W 74/0833

(57) ABSTRACT

Apparatuses, methods, and systems are disclosed for communicating based on an SSB burst configuration. One method includes receiving a plurality of synchronization signal/physical broadcast channel block (“SSB”) burst configurations of a cell. Each SSB burst configuration of the plurality of SSB burst configurations comprises information indicating SSB positions in an SSB burst. The method includes communicating with a network node of the cell based on a default SSB burst configuration. The default SSB burst configuration is selected from the plurality of SSB burst configurations.

### FIELD

The subject matter disclosed herein relates generally to wireless communications and more particularly relates to communicating based on an SSB burst configuration.

### BACKGROUND

In certain wireless communications networks, smart repeaters may be used. In such networks, some communications may be inefficient and/or include unnecessary noise.

### BRIEF SUMMARY

Methods for communicating based on an SSB burst configuration are disclosed. Apparatuses and systems also perform the functions of the methods. One embodiment of a method includes receiving, by a user equipment, a plurality of synchronization signal/physical broadcast channel block (“SSB”) burst configurations of a cell. Each SSB burst configuration of the plurality of SSB burst configurations comprises information indicating SSB positions in an SSB burst. In some embodiments, the method includes communicating with a network node of the cell based on a default SSB burst configuration. The default SSB burst configuration is selected from the plurality of SSB burst configurations.

One apparatus for communicating based on an SSB burst configuration includes a user equipment. In some embodiments, the apparatus includes a transceiver that: receives a plurality of synchronization signal/physical broadcast channel block (“SSB”) burst configurations of a cell, wherein each SSB burst configuration of the plurality of SSB burst configurations comprises information indicating SSB positions in an SSB burst; and communicates with a network node of the cell based on a default SSB burst configuration. The default SSB burst configuration is selected from the plurality of SSB burst configurations.

Another embodiment of a method for communicating based on an SSB burst configuration includes transmitting, from a network device, a plurality of synchronization signal/physical broadcast channel block (“SSB”) burst configurations of a cell. Each SSB burst configuration of the plurality of SSB burst configurations comprises information indicating SSB positions in an SSB burst. In some embodiments, the method includes communicating with a user equipment (“UE”) based on a default SSB burst configuration. The default SSB burst configuration is selected from the plurality of SSB burst configurations.

Another apparatus for communicating based on an SSB burst configuration includes a network device. In some embodiments, the apparatus includes a transceiver that: transmits a plurality of synchronization signal/physical broadcast channel block (“SSB”) burst configurations of a cell, wherein each SSB burst configuration of the plurality of SSB burst configurations comprises information indicating SSB positions in an SSB burst; and communicates with a user equipment (“UE”) based on a default SSB burst configuration. The default SSB burst configuration is selected from the plurality of SSB burst configurations.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for communicating based on an SSB burst configuration;

FIG. 2 is a schematic block diagram illustrating one embodiment of an apparatus that may be used for communicating based on an SSB burst configuration;

FIG. 3 is a schematic block diagram illustrating one embodiment of an apparatus that may be used for communicating based on an SSB burst configuration;

FIG. 4 illustrates one embodiment of an ServingCellConfigCommonSIB IE;

FIGS. 5 through 7 are schematic block diagrams illustrating one embodiment of multiple SSB burst configurations for multiple network nodes in a cell;

FIG. 8 is a block diagram illustrating one embodiment of a system having multiple network nodes in a cell;

FIG. 9 is a flow chart diagram illustrating one embodiment of a method for communicating based on an SSB burst configuration; and

FIG. 10 is a flow chart diagram illustrating another embodiment of a method for communicating based on an SSB burst configuration.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

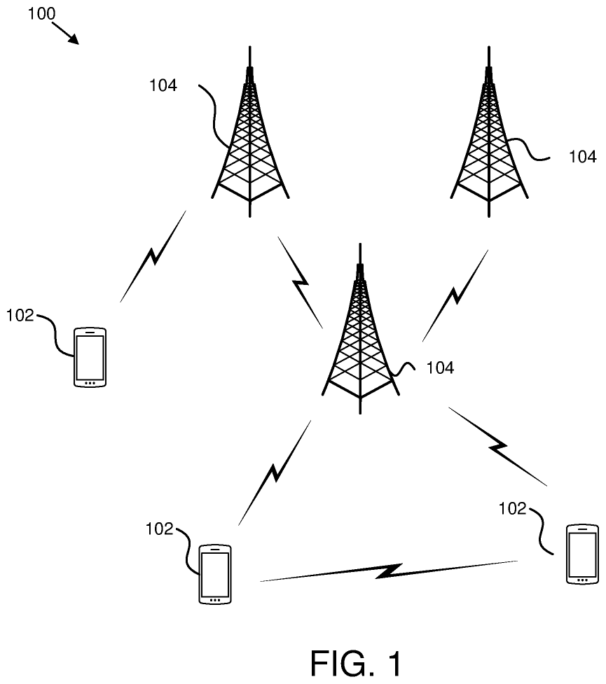

FIG. 1 depicts an embodiment of a wireless communication system 100 for communicating based on an SSB burst configuration. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive a plurality of synchronization signal/physical broadcast channel block (“SSB”) burst configurations of a cell. Each SSB burst configuration of the plurality of SSB burst configurations comprises information indicating SSB positions in an SSB burst. In some embodiments, the remote unit 102 may communicate with a network node of the cell based on a default SSB burst configuration. The default SSB burst configuration is selected from the plurality of SSB burst configurations. Accordingly, the remote unit 102 may be used for communicating based on an SSB burst configuration.

In certain embodiments, a network unit 104 may transmit a plurality of synchronization signal/physical broadcast channel block (“SSB”) burst configurations of a cell. Each SSB burst configuration of the plurality of SSB burst configurations comprises information indicating SSB positions in an SSB burst. In some embodiments, the network unit 104 may communicate with a user equipment (“UE”) based on a default SSB burst configuration. The default SSB burst configuration is selected from the plurality of SSB burst configurations. Accordingly, the network unit 104 may be used for communicating based on an SSB burst configuration.

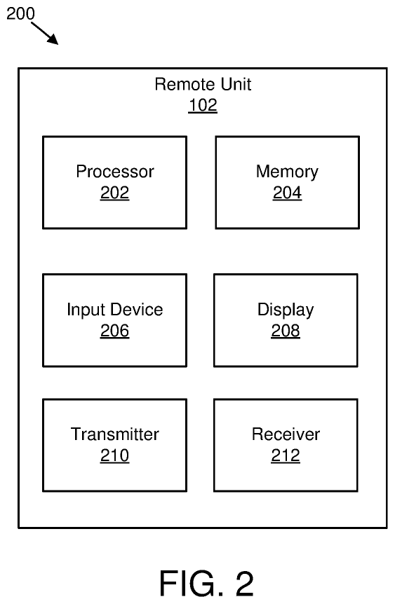

FIG. 2 depicts one embodiment of an apparatus 200 that may be used for communicating based on an SSB burst configuration. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

In certain embodiments, the transceiver: receives a plurality of synchronization signal/physical broadcast channel block (“SSB”) burst configurations of a cell, wherein each SSB burst configuration of the plurality of SSB burst configurations comprises information indicating SSB positions in an SSB burst; and communicates with a network node of the cell based on a default SSB burst configuration. The default SSB burst configuration is selected from the plurality of SSB burst configurations.

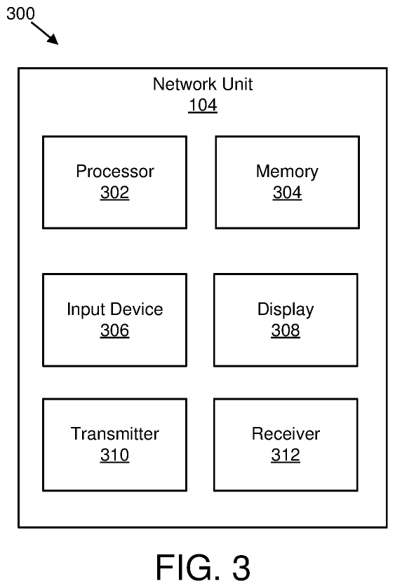

FIG. 3 depicts one embodiment of an apparatus 300 that may be used for communicating based on an SSB burst configuration. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the transceiver: transmits a plurality of synchronization signal/physical broadcast channel block (“SSB”) burst configurations of a cell, wherein each SSB burst configuration of the plurality of SSB burst configurations comprises information indicating SSB positions in an SSB burst; and communicates with a user equipment (“UE”) based on a default SSB burst configuration. The default SSB burst configuration is selected from the plurality of SSB burst configurations.

In certain embodiments, radio frequency (“RF”) repeaters may be used to supplement a coverage provided by regular full-stack cells. An RF repeater may not simply perform an amplify-and-forward operation without being able to take into account various factors such as semi-static and/or dynamic downlink and/or uplink configuration, adaptive transmitter and/or receiver spatial beamforming, ON-OFF status, and so forth.

In some embodiments, a smart repeater and/or an enhanced RF repeater has the capability to receive and process side control information from a network. The side control information may allow the smart repeater to perform an amplify-and-forward operation in a more efficient manner. Potential benefits of using the side control information may include mitigation of unnecessary noise amplification, transmission and reception with better spatial directivity, and/or simplified network integration.

In various embodiments, a smart repeater may maintain a gNB-repeater link and a repeater-UE link simultaneously on the same frequency by using different antenna panels (e.g., potentially with different antenna orientations (e.g., uplink tilt for the gNB-repeater link and down-tilt for the repeater-UE link)). Thus, downlink (“DL”) signals and/or channels transmitted from a gNB in a slot may be received and re-transmitted by the smart repeater within the same slot. Similarly, uplink (“UL”) signals and/or channels transmitted by a user equipment (“UE”) in a slot may be received and re-transmitted by the smart repeater within the same slot.

In certain embodiments, multiple low-transmit-power network nodes, such as multiple transmission and reception points (“TRPs”) deployed within a cell, may be beneficial (e.g., to overcome channel blockage in high frequency bands and/or may increase spectral efficiency based on spectral reuse if combined with proper interference management).

In some embodiments, both a smart repeater and a remote TRP may create additional spatial coverage different from a base station by employing a set of beams different from a set of beams that the base station uses. In various embodiments, a discovery signal may be flexibly provided taking into account network energy consumption and interference management (e.g., if a smart repeater and/or a remote TRP is deployed in a cell).

In certain embodiments, a cell search is a procedure for a UE to acquire time and frequency synchronization with a cell and to detect a physical layer cell identifier (“ID”) of the cell.

In some embodiments, a UE receives the following synchronization signals (“SS”) to perform a cell search: a primary synchronization signal (“PSS”) and secondary synchronization signal (“SSS”).

In various embodiments, a UE assumes that reception occasions of a physical broadcast channel (“PBCH”), PSS, and SSS are in consecutive symbols, and form a SS and/or PBCH (“SS/PBCH”) block. In such embodiments, the UE assumes that SSS, PBCH demodulation reference signal (“DM-RS”), and PBCH data have the same energy per resource element (“EPRE”). Moreover, the UE may assume that the ratio of PSS EPRE to SSS EPRE in a SS/PBCH block is either 0 dB or 3 dB. If the UE has not been provided dedicated higher layer parameters, the UE may assume that the ratio of PDCCH DMRS EPRE to SSS EPRE is within −8 dB and 8 dB if the UE monitors physical downlink control channels (“PDCCHs”) for a downlink control information (“DCI”) format 1_0 with cyclic redundancy check (“CRC”) scrambled by system information (“SI”) radio network temporary identifier (“RNTI”) (“SI-RNTI”), paging RNTI (“P-RNTI”), or random access RNTI (“RA-RNTI”).

In certain embodiments, for a half frame with SS/PBCH blocks, a first symbol indexes for candidate SS/PBCH blocks are determined according to a subcarrier spacing (“SCS”) of SS/PBCH blocks as follows, where index 0 corresponds to the first symbol of the first slot in a half-frame.

For Case A—15 kHz SCS: the first symbols of the candidate SS/PBCH blocks have indexes of {2, 8}+14·n wherein: 1) for operation without shared spectrum channel access: a) for carrier frequencies smaller than or equal to 3 GHz, n=0, 1, b) for carrier frequencies within FR1 larger than 3 GHz, n=0, 1, 2, 3, and c) for operation with shared spectrum channel access, n=0, 1, 2, 3, 4.

For Case B—30 kHz SCS: the first symbols of the candidate SS/PBCH blocks have indexes {4, 8, 16, 20}+28·n, wherein: 1) for carrier frequencies smaller than or equal to 3 GHz, n=0 and 2) for carrier frequencies within FR1 larger than 3 GHz, n=0, 1.

For Case C—30 kHz SCS: the first symbols of the candidate SS/PBCH blocks have indexes {2, 8}+14·n, wherein: 1) for operation without shared spectrum channel access: a) for paired spectrum operation—for carrier frequencies smaller than or equal to 3 GHz, n=0, 1 and for carrier frequencies within FR1 larger than 3 GHz, n=0, 1, 2, 3, b) for unpaired spectrum operation—for carrier frequencies smaller than 1.88 GHz, n=0, 1 and for carrier frequencies within FR1 equal to or larger than 1.88 GHz, n=0, 1, 2, 3 and c) for operation with shared spectrum channel access, n=0, 1, 2, 3, 4, 5, 6, 7, 8, 9.

For Case D—120 kHz SCS: the first symbols of the candidate SS/PBCH blocks have indexes {4, 8, 16, 20}+28·n, wherein for carrier frequencies within FR2, n=0, 1, 2, 3, 5, 6, 7, 8, 10, 11, 12, 13, 15, 16, 17, 18.

For Case E—240 kHz SCS: the first symbols of the candidate SS/PBCH blocks have indexes {8, 12, 16, 20, 32, 36, 40, 44}+56·n, wherein for carrier frequencies within FR2, n=0, 1, 2, 3, 5, 6, 7, 8.

From Cases A through E, if the SCS of SS/PBCH blocks is not provided by ssbSubcarrierSpacing, applicable cases for a cell may depend on a respective frequency band. A same case may apply for all SS/PBCH blocks on the cell. If a 30 kHz SS/PBCH block SCS is indicated by ssbSubcarrierSpacing, Case B applies for frequency bands with only 15 kHz SS/PBCH block SCS, and the case specified for 30 kHz SS/PBCH block SCS applies for frequency bands with 30 kHz SS/PBCH block SCS or both 15 kHz and 30 kHz SS/PBCH block SCS. For a UE configured to operate with carrier aggregation over a set of cells in a frequency band of frequency range 2 (“FR2”) or with frequency-contiguous carrier aggregation over a set of cells in a frequency band of frequency range 1 (“FR1”), if the UE is provided SCS values by ssbSubcarrierSpacing for receptions of SS/PBCH blocks on any cells from the set of cells, the UE expects the SCS values to be same.

In certain embodiments, candidate SS/PBCH blocks in a half frame are indexed in an ascending order in time from 0 to L̅ₘₐₓ−1, where L̅ₘₐₓ is determined according to SS/PBCH block patterns for Cases A through E. Lₘₐₓ is a maximum number of SS/PBCH block indexes in a cell, and the maximum number of transmitted SS/PBCH blocks within a half frame is Lₘₐₓ. For operation without shared spectrum channel access, Lₘₐₓ=L̅ₘₐₓ and for operation with shared spectrum channel access, Lₘₐₓ=8 for L̅ₘₐₓ=10 and 15 kHz SCS of SS/PBCH blocks and for L̅ₘₐₓ=20 and 30 kHz SCS of SS/PBCH blocks.

For L̅ₘₐₓ=4, a UE determines the 2 least significant bit (“LSB”) bits of a candidate SS/PBCH block index per half frame from a one-to-one mapping with an index of the DM-RS sequence transmitted in the PBCH. For L̅ₘₐₓ>4, a UE determines the 3 LSB bits of a candidate SS/PBCH block index per half frame from a one-to-one mapping with an index of the DM-RS sequence transmitted in the PBCH. Further: 1) for L̅ₘₐₓ=10, the UE determines the 1 most significant byte (“MSB”) bit of the candidate SS/PBCH block index from PBCH payload bit ā_{Ā+7}; 2) for L̅ₘₐₓ=20, the UE determines the 2 MSB bits of the candidate SS/PBCH block index from PBCH payload bits ā_{Ā+6}, ā_{Ā+7}; and/or 3) for L̅ₘₐₓ=64, the UE determines the 3 MSB bits of the candidate SS/PBCH block index from PBCH payload bits ā_{Ā+5}, ā_{Ā+6}, ā_{Ā+7}.

In some embodiments, a UE may be provided per serving cell, by ssb-periodicityServingCell, a periodicity of half frames for reception of SS/PBCH blocks for a serving cell. If the UE is not configured with aperiodicity of the half frames for receptions of the SS/PBCH blocks, the UE assumes a periodicity of a half frame. Moreover, a UE assumes that the periodicity is the same for all SS/PBCH blocks in the serving cell.

In various embodiments, for initial cell selection, a UE may assume that half frames with SS/PBCH blocks occur with a periodicity of 2 frames. In certain embodiments, for operation without shared spectrum channel access, an SS/PBCH block index may be the same as a candidate SS/PBCH block index.

In some embodiments, upon detection of a SS/PBCH block, a UE determines from a master information block (“MIB”) that a control resource set (“CORESET”) for Type0-PDCCH common search space (“CSS”) set is present if k_{SSB}<24 for FR1 or if k_{SSB}<12 for FR2. The UE determines from MIB that a CORESET for Type0-PDCCH CSS set is not present if k_{SSB}>23 for FR1 or if k_{SSB}>11 for FR2. Moreover, the CORESET for Type0-PDCCH CSS set may be provided by PDCCH-ConfigCommon.

In various embodiments, for a serving cell without transmission of SS/PBCH blocks, a UE acquires time and frequency synchronization with the serving cell based on receptions of SS/PBCH blocks on a primary cell (“PCell”), on a primary serving cell (“PSCell”), or on a secondary cell (“SCell”) if applicable, of a cell group for a serving cell.

In certain embodiments, an SS/PBCH block (“SSB”) burst refers to a set of SSBs within a half frame (e.g., 5 millisecond) in 3GPP new radio (“NR”).

In some embodiments, there may be multiple SSB burst configurations.

In various embodiment, a UE receives information for a plurality of SSB burst configurations (e.g., ssb-BurstConfigList), each SSB burst configuration (e.g., SSB-BurstConfig) potentially associated with a different network node (e.g., a TRP, a repeater) of a cell. In one example, each SSB burst configuration of the plurality of SSB burst configurations include information of SSB positions in burst (e.g., information of actually transmitted SSBs within a SSB transmission window, such as a parameter ssb-PositionsInBurst-r18), a SSB periodicity (e.g., a parameter ssb-PeriodicityServingCell-r18), and an SSB transmit power value (e.g., a parameter ss-PBCH-BlockPower-r18). This may allow a network entity to flexibly configure and/or control cell discovery signal (e.g., SSBs) transmissions based on desired spatial coverage, need for interference management, and need for energy efficient operation. For example, a repeater deployed in a cell-edge to extend a cell coverage in a particular spatial direction transmits one or more SSBs with lower transmit power than a base station deployed in a cell-center to reduce the interference to a neighbor cell.

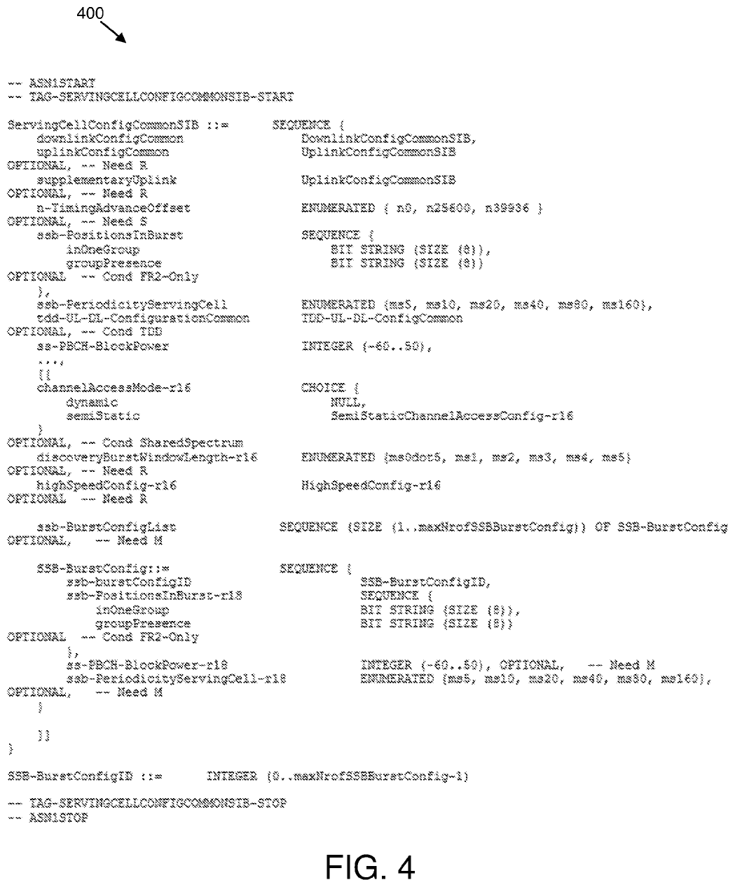

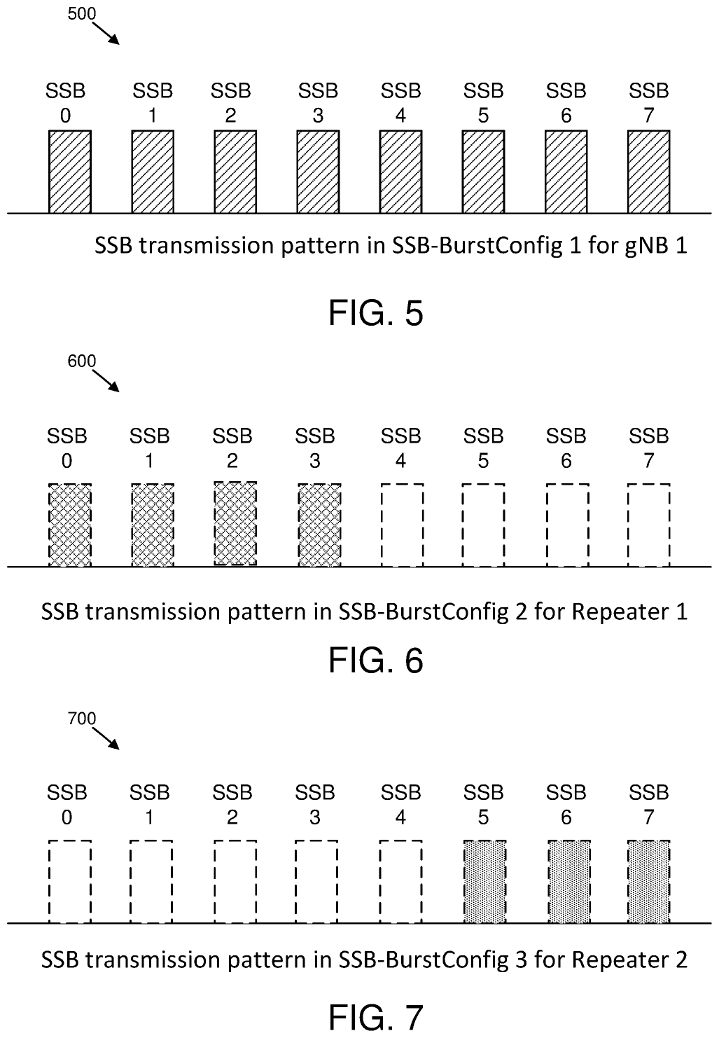

In certain embodiments, first and second SSB burst configurations of a plurality of SSB burst configurations indicate at least one transmitted SSB with a same candidate SSB index. That is, multiple network nodes of a cell transmit one or more SSBs in one or more common SSB time-domain positions within a half-frame (or within a SSB transmission window) in a single-frequency network (“SFN”) transmission manner, as shown in FIG. 4 and FIG. 5.

In one example, a UE expects that first and second SSB burst configurations of a plurality of SSB burst configurations indicate a same SSB periodicity if they indicate at least one transmitted SSB with a same SSB index. In case that the first SSB burst configuration includes multiple SSB periodicities, each SSB periodicity applicable to a subset of SSB indices, the UE expects that the first and second SSB burst configurations indicate a common SSB periodicity for the at least one transmitted SSB with the same SSB index.

In another example, if a UE receives first and second SSB burst configurations of a plurality of SSB burst configurations indicating at least one transmitted SSB with a same SSB index, the UE may receive information of at least one selected from a first scaling value and a second scaling value, where the UE applies the first scaling value to a first SSB transmit power of a first SSB burst configuration and the second scaling value to a second SSB transmit power of a second SSB burst configuration in order to compute an effective transmit power of the at least one transmitted SSB with the same SSB index. For example, the effective transmit power of the at least one transmitted SSB with the same SSB index is computed as a sum of the first SSB transmit power scaled by the first scaling value and the second SSB transmit power scaled by the second scaling value, and the resulting effective transmit power may be used for pathloss estimation.

In some embodiments, if a UE receives multiple SSB burst configurations, the UE may assume that SSBs of a given SSB burst configuration are transmitted by a co-located transmitter, and may assume at least one of quasi-co-location (“QCL”) types (e.g., QCL-TypeC—such as SSBs of the given SSB burst configuration being quasi-co-located with respect to Doppler shift and average delay).

In various embodiments, a UE receives multiple SSB burst configurations of a cell via a broadcast message (e.g., system information block 1 (“SIB1”) or other system information (“SI”) messages). In certain embodiments, a UE receives multiple SSB burst configurations of a cell via a dedicated radio resource control (“RRC”) message (e.g., provided in ServingCellConfig).

FIG. 4 illustrates one embodiment of an ServingCellConfigCommonSIB information element (“IE”) 400. The ServingCellConfigCommonSIB IE is used to configure cell specific parameters of a UE's serving cell in SIB1.

TABLE 1
groupPresence
This field is present when maximum number of SS/PBCH blocks per half frame equals to 64 as defined in TS
38.213, clause 4.1. The first/leftmost bit corresponds to the SS/PBCH index 0-7, the second bit corresponds to
SS/PBCH block 8-15, and so on. Value 0 in the bitmap indicates that the SSBs according to inOneGroup are
absent. Value 1 indicates that the SS/PBCH blocks are transmitted in accordance with inOneGroup.
inOneGroup
When maximum number of SS/PBCH blocks per half frame equals to 4, only the 4 leftmost bits are valid; the UE
ignores the 4 rightmost bits. When maximum number of SS/PBCH blocks per half frame equals to 8, all 8 bits are
valid. The first/leftmost bit corresponds to SS/PBCH block index 0, the second bit corresponds to SS/PBCH
block index 1, and so on. When maximum number of SS/PBCH blocks per half frame equals to 64, all 8 bit are
valid; The first/leftmost bit corresponds to the first SS/PBCH block index in the group (i.e., to SSB index 0, 8,
and so on); the second bit corresponds to the second SS/PBCH block index in the group (i.e., to SSB index 1, 9,
and so on), and so on. Value 0 in the bitmap indicates that the corresponding SS/PBCH block is not transmitted
while value 1 indicates that the corresponding SS/PBCH block is transmitted.
ssb-PositionsInBurst
Time domain positions of the transmitted SS-blocks in an SS-burst. For operation with shared spectrum channel
access, only mediumBitmap is used. The UE assumes that a bit at position k > N_{SSB}^{QCL} is 0, where N_{SSB}^{QCL} is obtained
from MIB as specified in TS 38.213, clause 4.1. For operation with shared spectrum channel access, only
inOneGroup is used and the UE interprets this field same as mediumBitmap in ServingCellConfigCommon.
ss-PBCH-BlockPower
Average energy per resource element (EPRE) of the resources elements that carry secondary synchronization
signals in dBm that the network used for SSB transmission.
ssb-periodicityServingCell
The SSB periodicity in ms for the rate matching purpose. If the field is absent, the UE applies the value ms5.

In certain embodiments, a legacy UE may not be able to receive information of a plurality of SSB burst configurations but may receive one legacy configuration parameter ssb-PositionsInBurst for information of time-domain positions of actually transmitted SSBs within a half frame (or within a SSB transmission window) and one legacy configuration parameter ssb-PeriodicityServingCell for information of an SSB periodicity (e.g., assuming that each SSB of an SSB burst has the same periodicity).

In one example, a network entity may indicate a union of a plurality of SSB position configurations (e.g., a plurality of ssb-PositionsInBurst-r18 parameters) in a legacy configuration parameter ssb-PositionsInBurst. In another example, a network entity may indicate via a legacy configuration parameter ssb-PositionsInBurst, one SSB position configuration of the plurality of SSB position configurations which is associated with a base station of a cell (e.g., a network node located in a cell center). In other examples, a network entity may indicate, via a legacy configuration parameter ssb-PositionsInBurst, a subset of SSB positions selected from a set of SSB positions that is based on the union of the plurality of SSB position configurations. The network entity may avoid any potential interference on legacy UEs caused by SSB transmissions on one or more SSB positions of the set of SSB positions, which is not indicated via the legacy parameter ssb-PositionsInBurst based on scheduling restriction on resources overlapping with the one or more SSB positions.

In some embodiments, there may be a default SSB burst configuration with multiple SSB burst configurations.

In various embodiments, if a UE receives multiple SSB burst configurations (e.g., multiple configurations of SSB positions in burst, multiple SSB periodicities, and/or multiple SSB transmit power values), the UE determines a default SSB burst configuration (e.g., a default configuration of SSB positions in burst, a default SSB periodicity, and/or a default SSB transmit power), where SSB positions in burst for the default SSB burst configuration may be used for physical downlink shared channel (“PDSCH”) resource mapping, PDCCH resource mapping, and random access channel (“RACH”) resource mapping.

In certain embodiments, a UE may ignore legacy configuration parameters for SSB positions in burst, a SSB periodicity, and a SSB transmit power, if the UE receives multiple SSB burst configurations (e.g., ssb-BurstConfigList). Further, the UE may assume that an SSB burst configuration with the lowest SSB burst configuration identity (e.g., a parameter SSB-BurstConfigID set to zero) is a default SSB burst configuration, if not explicitly configured. If a network entity sends the multiple SSB burst configurations via a system information message or as part of cell-specific parameters, the default SSB burst configuration is determined cell-specifically. In some embodiments, a network entity may configure different sets of SSB burst configurations and different default SSB burst configurations for different UEs (e.g., via a dedicated higher-layer message such as dedicated RRC message), if UEs are in an RRC connected state.

In various embodiments, a UE considers legacy cell-specific configuration parameters for SSB positions in burst, a SSB periodicity, and a SSB transmit power, as a default SSB burst configuration. That is, a default SSB burst configuration is configured commonly for UEs in a cell.

In certain embodiments, a UE receives an indication of a default SSB burst configuration selected from multiple SSB burst configurations via a dedicated RRC message (e.g., provided in ServingCellConfig or via a medium access control (“MAC”) control element (“CE”). A network entity may select and indicate a default SSB burst configuration for the UE based on UE measurement reports and/or estimated and/or predicted UE locations within a cell.

In some embodiments, the default SSB burst configuration comprises SSB positions that are at least the union of the SSB positions in the multiple SSB burst configurations. In some examples, the UE may determine the SSB positions of the default SSB burst configuration as the union of the of the SSB positions in the multiple SSB burst configurations.

In certain embodiments, the SSB positions of a SSB burst configuration of the multiple SSB burst configurations is a subset of the SSB positions of the default SSB burst configuration. In some examples, the UE may not expect to be configured with a SSB burst configuration that comprises SSB burst positions that do not overlap with or included in the SSB burst positions of the default SSB burst configuration.

In some embodiments, each SSB burst configuration of multiple SSB burst configurations corresponds to a virtual small cell within a wide-area cell. All virtual small cells of the multiple SSB burst configurations are associated with a same physical cell identity (“PCID”) of the wide-area cell, while they may have separate SSB power, separate SSB periodicity, and/or separate set of SSBs, which make an impact on PDSCH and/or PDCCH rate-matching, determination of association of SSBs with RACH occasions, and SSB selection for a random access procedure. Compared to legacy small cell deployment with separate PCIDs for different small cells, the UE can perform layer-1 (“L1”) and/or layer-2 (“L2”) based mobility with virtual small cells (e.g., changing a default SSB burst configuration based on reception of a MAC CE indicating the default SSB burst configuration). When a network decides to turn off a network node associated with a SSB burst configuration (e.g., a virtual small cell) within the wide-area cell, UEs served by the network node may not have to perform a serving cell change (e.g., a handover, layer-3 (“L3”) based mobility) but can simply change a default SSB burst configuration.

In various embodiments, all SSBs in a SSB burst have the same TX power and the same periodicity. In addition, a cell may have only one SSB burst pattern. An SSB burst pattern (e.g., SSB positions in burst) makes an impact on SSB-RACH occasion association and SIB1 and/or paging PDCCH monitoring occasions. Thus, if one network node within a cell and corresponding SSBs are turned off, all UEs in the cell have to re-compute SSB-RACH occasion association and SIB1 and/or paging PDCCH monitoring occasions change. With multiple SSB burst configurations and dynamic indication of a default SSB burst configuration, only UEs who were served by the turned-off network node need to update a default SSB burst configuration and change SSB-RACH occasion association and SIB1 and/or paging PDCCH monitoring occasions.

In some embodiments, there may be PDSCH resource mapping.

In one example, if receiving a PDSCH scheduled with SI-RNTI and a system information indicator in DCI is set to 0 (e.g., the PDSCH scheduled by the DCI carries SIB1), a UE may assume that no SS/PBCH block of a default SSB burst configuration of a cell is transmitted in REs used by the UE for a reception of the PDSCH. Alternatively, a UE may assume that no SSB of any SSB burst configuration of multiple SSB burst configurations of a cell is transmitted in REs used by the UE for a reception of a PDSCH carrying SIB1.

In another example, if receiving a PDSCH scheduled by a PDCCH with cyclic redundancy code (“CRC”) scrambled by RA-RNTI, message B (“MSGB”) RNTI (“MSGB-RNTI”), P-RNTI, temporary cell (“TC”) RNTI (“TC-RNTI”), or SI-RNTI and a system information indicator in DCI is set to 1 (e.g., the PDSCH scheduled by the DCI carries a SI message), a UE assumes SS/PBCH block transmission according to ssb-PositionsInBurst of a default SSB burst configuration, and if the PDSCH resource allocation overlaps with physical resource blocks (“PRBs”) containing SS/PBCH block transmission resources the UE shall assume that the PRBs containing the SS/PBCH block transmission resources are not available for PDSCH in orthogonal frequency division multiplexing (“OFDM”) symbols where the SS/PBCH block is transmitted. The default SSB burst configuration may be cell-specifically configured.

In an example, if receiving a PDSCH scheduled by a PDCCH with CRC scrambled by C-RNTI, modulating and coding scheme (“MCS”) cell (“C”) RNTI (“MCS-C-RNTI”), configured scheduled (“CS”) RNTI (“CS-RNTI”) or when receiving a PDSCH with semi-persistent scheduling (“SPS”), a UE assumes SS/PBCH block transmission according to ssb-PositionsInBurst of a default SSB burst configuration, and if the PDSCH resource allocation overlaps with PRBs containing SS/PBCH block transmission resources, the UE may assume that the PRBs containing the SS/PBCH block transmission resources are not available for PDSCH in OFDM symbols where the SS/PBCH block is transmitted. The default SSB burst configuration may be UE-specifically configured.

In various embodiments, for operation with shared spectrum channel access, SS/PBCH block transmission according to ssb-PositionsInBurst of a SSB burst configuration represents all of the candidate SS/PBCH blocks corresponding to SS/PBCH block indices provided by ssb-PositionsInBurst of the SSB burst configuration.

In certain embodiments, there may be PDCCH resource mapping.

In one example, for monitoring of a PDCCH candidate by a UE, if the UE: has received at least one SSB burst configuration either in a system information message (e.g., SIB1) or via a dedicated RRC message, does not monitor PDCCH candidates in a Type0-PDCCH CSS set (e.g., a search space set for SIB1 delivery), and at least one resource element (“RE”) for a PDCCH candidate overlaps with at least one RE of a candidate SS/PBCH block corresponding to a SS/PBCH block index provided by ssb-PositionsInBurst of a default SSB burst configuration of the at least one SSB burst configuration, the UE is not required to monitor the PDCCH candidate.

In some embodiments, there may be random access channel (“RACH”) resource mapping. In NR, a network entity configures a number of contention based preambles per SSB index per valid physical RACH (“PRACH”) occasion for all SSB indexes corresponding to transmitted SSBs (e.g., by ssb-perRACH-OccasionAndCB-PreamblesPerSSB for Type-1 random access procedure, msgA-SSB-PerRACH-OccasionAndCB-PreamblesPerSSB for Type-2 random access procedure with separate configuration of PRACH occasions, or msgA-CB-PreamblesPerSSB-PerSharedRO for Type-2 random access procedure with common configuration of PRACH occasions with Type-1 random access procedure). Further, the network entity configures each SSB index to be mapped to the same number of one or multiple consecutive valid PRACH occasions for all SSB indexes corresponding to transmitted SSBs.

In various embodiments, SSB indexes corresponding to actually transmitted SSBs are mapped to valid PRACH occasions in the following order: 1) in increasing order of preamble indexes within a single PRACH occasion; 2) in increasing order of frequency resource indexes for frequency multiplexed PRACH occasions; 3) in increasing order of time resource indexes for time multiplexed PRACH occasions within a PRACH slot; and 4) in increasing order of indexes for PRACH slots.

In an example, an association period, starting from frame 0, for mapping SS/PBCH block indexes to PRACH occasions is the smallest value in the set determined by the PRACH configuration period such that N_{Tx}^{SSB} SS/PBCH block indexes are mapped at least once to the PRACH occasions within the association period, where a UE obtains N_{Tx}^{SSB} from the value of ssb-PositionsInBurst of a default SSB burst configuration. If after an integer number of SS/PBCH block indexes to PRACH occasions mapping cycles within the association period there is a set of PRACH occasions or PRACH preambles that are not mapped to N_{Tx}^{SSB} SS/PBCH block indexes, no SS/PBCH block indexes are mapped to the set of PRACH occasions or PRACH preambles. An association pattern period includes one or more association periods and is determined so that a pattern between PRACH occasions and SS/PBCH block indexes repeats at most every 160 msec. PRACH occasions not associated with SS/PBCH block indexes after an integer number of association periods, if any, are not used for PRACH transmissions.

TABLE 2
Mapping between PRACH configuration period and SS/PBCH
block to PRACH occasion association period

| PRACH configuration period | Association period (number of PRACH |
|---|---|
| (msec) | configuration periods) |
| 10 | {1, 2, 4, 8, 16} |
| 20 | {1, 2, 4, 8} |
| 40 | {1, 2, 4} |
| 80 | {1, 2} |
| 160 | {1} |

In certain embodiments, if a UE receives multiple SSB burst configurations, the UE determines a PRACH/RACH configuration (or a set of random access parameters, e.g., rsrp-ThresholdSSB) associated with each of the multiple SSB burst configurations. In an example, SSB burst configurations with the same number of transmitted SSBs may be mapped to a common PRACH/RACH configuration, while SSB burst configurations with different numbers of transmitted SSBs are mapped to different PRACH/RACH configurations. In another example, the UE receives one or more PRACH configurations and association information of a PRACH configuration and a SSB burst configuration.

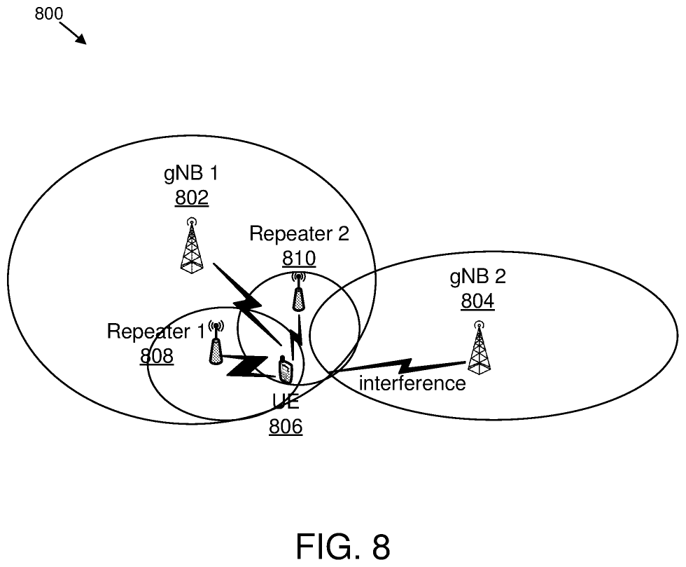

FIGS. 5 through 7 are schematic block diagrams illustrating one embodiment of multiple SSB burst configurations for multiple network nodes in a cell that may be applied to the system of FIG. 8. Specifically, FIG. 5 illustrates one embodiment of an SSB transmission pattern 500 in SSB-BurstConfig 1 for gNB 1. Further, FIG. 6 illustrates one embodiment of an SSB transmission pattern 600 in SSB-BurstConfig 2 for Repeater 1, where Repeater 1 transmits SSB 0, SSB 1, SSB 2, and SSB 3. Moreover, FIG. 7 illustrates one embodiment of an SSB transmission pattern 700 in SSB-BurstConfig 3 for Repeater 2, where Repeater 2 transmits SSB 5, SSB 6, and SSB 7.

FIG. 8 is a block diagram illustrating one embodiment of a system 800 having multiple network nodes in a cell. The system includes a gNB 1 802, a gNB 2 804, a UE 806, a Repeater 1 808, and a Repeater 2 810. The Repeater 1 808 and/or the Repeater 2 810 may repeat transmissions from the gNB 1 802 to the UE 806 (e.g., such as based on transmissions shown in FIGS. 5 through 7.

In some embodiments, the terms antenna, panel, and antenna panel are used interchangeably. An antenna panel may be hardware that is used for transmitting and/or receiving radio signals at frequencies lower than 6 GHz (e.g., frequency range 1 (“FR1”)), or higher than 6 GHz (e.g., frequency range 2 (“FR2”) or millimeter wave (“mmWave”)). In certain embodiments, an antenna panel may include an array of antenna elements. Each antenna element may be connected to hardware, such as a phase shifter, that enables a control module to apply spatial parameters for transmission and/or reception of signals. The resulting radiation pattern may be called a beam, which may or may not be unimodal and may allow the device to amplify signals that are transmitted or received from spatial directions.

In various embodiments, an antenna panel may or may not be virtualized as an antenna port. An antenna panel may be connected to a baseband processing module through a radio frequency (“RF”) chain for each transmission (e.g., egress) and reception (e.g., ingress) direction. A capability of a device in terms of a number of antenna panels, their duplexing capabilities, their beamforming capabilities, and so forth, may or may not be transparent to other devices. In some embodiments, capability information may be communicated via signaling or capability information may be provided to devices without a need for signaling. If information is available to other devices the information may be used for signaling or local decision making.

In some embodiments, a UE antenna panel may be a physical or logical antenna array including a set of antenna elements or antenna ports that share a common or a significant portion of a radio frequency (“RF”) chain (e.g., in-phase and/or quadrature (“I/Q”) modulator, analog to digital (“A/D”) converter, local oscillator, phase shift network). The UE antenna panel or UE panel may be a logical entity with physical UE antennas mapped to the logical entity. The mapping of physical UE antennas to the logical entity may be up to UE implementation. Communicating (e.g., receiving or transmitting) on at least a subset of antenna elements or antenna ports active for radiating energy (e.g., active elements) of an antenna panel may require biasing or powering on of an RF chain which results in current drain or power consumption in a UE associated with the antenna panel (e.g., including power amplifier and/or low noise amplifier (“LNA”) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In certain embodiments, depending on a UE's own implementation, a “UE panel” may have at least one of the following functionalities as an operational role of unit of antenna group to control its transmit (“TX”) beam independently, unit of antenna group to control its transmission power independently, and/pr unit of antenna group to control its transmission timing independently. The “UE panel” may be transparent to a gNB. For certain conditions, a gNB or network may assume that a mapping between a UE's physical antennas to the logical entity “UE panel” may not be changed. For example, a condition may include until the next update or report from UE or include a duration of time over which the gNB assumes there will be no change to mapping. A UE may report its UE capability with respect to the “UE panel” to the gNB or network. The UE capability may include at least the number of “UE panels.” In one embodiment, a UE may support UL transmission from one beam within a panel. With multiple panels, more than one beam (e.g., one beam per panel) may be used for UL transmission. In another embodiment, more than one beam per panel may be supported and/or used for UL transmission.

In some embodiments, an antenna port may be defined such that a channel over which a symbol on the antenna port is conveyed may be inferred from the channel over which another symbol on the same antenna port is conveyed.

In certain embodiments, two antenna ports are said to be quasi co-located (“QCL”) if large-scale properties of a channel over which a symbol on one antenna port is conveyed may be inferred from the channel over which a symbol on another antenna port is conveyed. Large-scale properties may include one or more of delay spread, Doppler spread, Doppler shift, average gain, average delay, and/or spatial receive (“RX”) parameters. Two antenna ports may be quasi co-located with respect to a subset of the large-scale properties and different subset of large-scale properties may be indicated by a QCL Type. For example, a qcl-Type may take one of the following values: 1) ‘QCL-TypeA’: {Doppler shift, Doppler spread, average delay, delay spread}; 2) ‘QCL-TypeB’: {Doppler shift, Doppler spread}; 3) ‘QCL-TypeC’: {Doppler shift, average delay}; and 4) ‘QCL-TypeD’: {Spatial Rx parameter}. Other QCL-Types may be defined based on combination of one or large-scale properties.

In various embodiments, spatial RX parameters may include one or more of: angle of arrival (“AoA”), dominant AoA, average AoA, angular spread, power angular spectrum (“PAS”) of AoA, average angle of departure (“AoD”), PAS of AoD, transmit and/or receive channel correlation, transmit and/or receive beamforming, and/or spatial channel correlation.

In certain embodiments, QCL-TypeA, QCL-TypeB, and QCL-TypeC may be applicable for all carrier frequencies, but QCL-TypeD may be applicable only in higher carrier frequencies (e.g., mmWave, FR2, and beyond), where the UE may not be able to perform omni-directional transmission (e.g., the UE would need to form beams for directional transmission). For a QCL-TypeD between two reference signals A and B, the reference signal A is considered to be spatially co-located with reference signal B and the UE may assume that the reference signals A and B can be received with the same spatial filter (e.g., with the same RX beamforming weights).

In some embodiments, an “antenna port” may be a logical port that may correspond to a beam (e.g., resulting from beamforming) or may correspond to a physical antenna on a device. In certain embodiments, a physical antenna may map directly to a single antenna port in which an antenna port corresponds to an actual physical antenna. In various embodiments, a set of physical antennas, a subset of physical antennas, an antenna set, an antenna array, or an antenna sub-array may be mapped to one or more antenna ports after applying complex weights and/or a cyclic delay to the signal on each physical antenna. The physical antenna set may have antennas from a single module or panel or from multiple modules or panels. The weights may be fixed as in an antenna virtualization scheme, such as cyclic delay diversity (“CDD”). A procedure used to derive antenna ports from physical antennas may be specific to a device implementation and transparent to other devices.

In certain embodiments, a transmission configuration indicator (“TCI”) state (“TCI-state”) associated with a target transmission may indicate parameters for configuring a quasi-co-location relationship between the target transmission (e.g., target RS of demodulation (“DM”) reference signal (“RS”) (“DM-RS”, “DMRS”) ports of the target transmission during a transmission occasion) and a source reference signal (e.g., synchronization signal block (“SSB”), channel state information (“CSI”) reference signal (“RS”) (“CSI-RS”), and/or sounding reference signal (“SRS”)) with respect to quasi co-location type parameters indicated in a corresponding TCI state. The TCI describes which reference signals are used as a QCL source, and what QCL properties may be derived from each reference signal. A device may receive a configuration of a plurality of transmission configuration indicator states for a serving cell for transmissions on the serving cell. In some embodiments, a TCI state includes at least one source RS to provide a reference (e.g., UE assumption) for determining QCL and/or a spatial filter.

In some embodiments, spatial relation information associated with a target transmission may indicate a spatial setting between a target transmission and a reference RS (e.g., SSB, CSI-RS, and/or SRS). For example, a UE may transmit a target transmission with the same spatial domain filter used for receiving a reference RS (e.g., DL RS such as SSB and/or CSI-RS). In another example, a UE may transmit a target transmission with the same spatial domain transmission filter used for the transmission of a RS (e.g., UL RS such as SRS). A UE may receive a configuration of multiple spatial relation information configurations for a serving cell for transmissions on a serving cell.

In certain embodiments, a UL TCI state is provided if a UE is configured with separate DL/UL TCI by RRC signaling. The UL TCI state may comprise a source reference signal which provides a reference for determining UL spatial domain transmission filter for the UL transmission (e.g., dynamic-grant/configured-grant based PUSCH, dedicated PUCCH resources) in a CC or across a set of configured CCs/BWPs.

In some embodiments, a joint DL/UL TCI state is provided if a UE is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for UE-dedicated PDCCH/PDSCH) and is used to determine UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

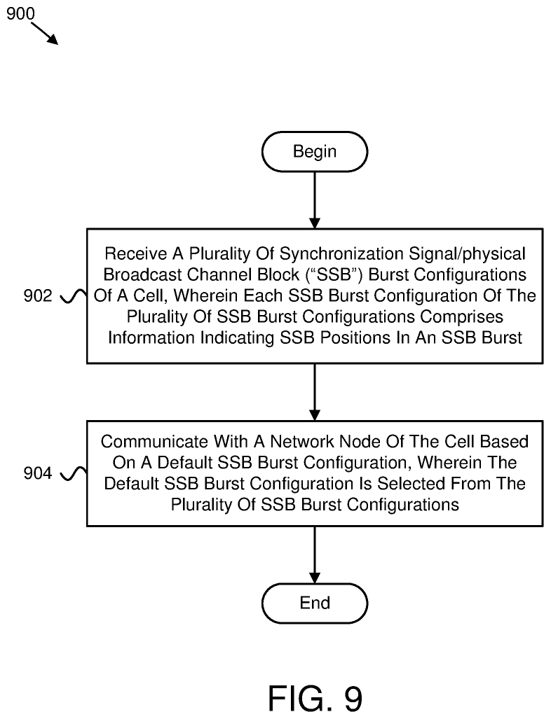

FIG. 9 is a flow chart diagram illustrating one embodiment of a method 900 for communicating based on an SSB burst configuration. In some embodiments, the method 900 is performed by an apparatus, such as the remote unit 102. In certain embodiments, the method 900 may be performed by a processor executing program code, for example, a microcontroller, a microprocessor, a CPU, a GPU, an auxiliary processing unit, a FPGA, or the like.

In various embodiments, the method 900 includes receiving 902, by a user equipment, a plurality of synchronization signal/physical broadcast channel block (“SSB”) burst configurations of a cell. Each SSB burst configuration of the plurality of SSB burst configurations comprises information indicating SSB positions in an SSB burst. In some embodiments, the method 900 includes communicating 904 with a network node of the cell based on a default SSB burst configuration. The default SSB burst configuration is selected from the plurality of SSB burst configurations.

In certain embodiments, each SSB burst configuration of the plurality of SSB burst configurations further comprises an SSB periodicity. In some embodiments, each SSB burst configuration of the plurality of SSB burst configurations further comprises an SSB transmit power value. In various embodiments, the cell comprises a plurality of network nodes and each network node of the plurality of network nodes corresponds to an SSB burst configuration of the plurality of SSB burst configurations.

In one embodiment, the method 900 further comprises receiving an indication indicating the default SSB burst configuration, wherein communicating with the network node comprises communicating with the network node based on the indicated default SSB burst configuration. In certain embodiments, the indication indicating the default SSB burst configuration is received via a dedicated radio resource control (“RRC”) message or via a medium access control (“MAC”) control element (“CE”). In some embodiments, the plurality of SSB burst configurations are received as a part of system information of the cell.

In various embodiments, the method 900 further comprises receiving association information for each SSB burst configuration of the plurality of SSB burst configurations with a random access configuration of a plurality of random access configurations, wherein communicating with the network node comprises performing a random access procedure according to a random access configuration associated with the default SSB burst configuration. In one embodiment, communicating with the network node comprises receiving a physical downlink channel signal, a physical downlink signal, or a combination thereof based on the default SSB burst configuration.

In certain embodiments, a first SSB burst configuration and a second SSB burst configuration of the plurality of SSB burst configurations comprise at least one SSB of a same SSB index transmitted with a same SSB periodicity. In some embodiments, the method 900 further comprises: receiving information indicating a first scaling value and a second scaling value; and computing an effective transmit power of the at least one SSB of the same SSB index by applying the first scaling value to a first SSB transmit power of the first SSB burst configuration and the second scaling value to a second SSB transmit power of the second SSB burst configuration.

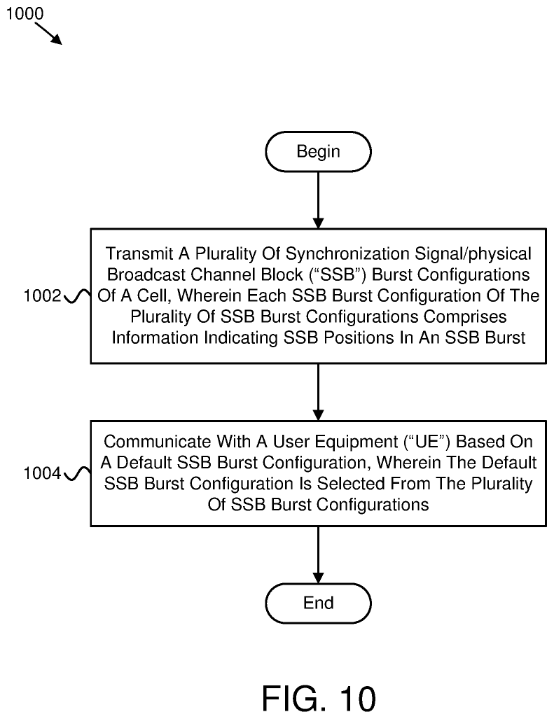

FIG. 10 is a flow chart diagram illustrating another embodiment of a method 1000 for communicating based on an SSB burst configuration. In some embodiments, the method 1000 is performed by an apparatus, such as the network unit 104. In certain embodiments, the method 1000 may be performed by a processor executing program code, for example, a microcontroller, a microprocessor, a CPU, a GPU, an auxiliary processing unit, a FPGA, or the like.

In various embodiments, the method 1000 includes transmitting 1002 a plurality of synchronization signal/physical broadcast channel block (“SSB”) burst configurations of a cell. Each SSB burst configuration of the plurality of SSB burst configurations comprises information indicating SSB positions in an SSB burst. In some embodiments, the method 1000 includes communicating 1004 with a user equipment (“UE”) based on a default SSB burst configuration. The default SSB burst configuration is selected from the plurality of SSB burst configurations.

In certain embodiments, each SSB burst configuration of the plurality of SSB burst configurations further comprises an SSB periodicity. In some embodiments, each SSB burst configuration of the plurality of SSB burst configurations further comprises an SSB transmit power value. In various embodiments, the cell comprises a plurality of network nodes and each network node of the plurality of network nodes corresponds to an SSB burst configuration of the plurality of SSB burst configurations.

In one embodiment, the method 1000 further comprises transmitting an indication indicating the default SSB burst configuration, wherein communicating with the UE comprises communicating with the UE based on the indicated default SSB burst configuration. In certain embodiments, the indication indicating the default SSB burst configuration is transmitted via a dedicated radio resource control (“RRC”) message or via a medium access control (“MAC”) control element (“CE”). In some embodiments, the plurality of SSB burst configurations are transmitted as a part of system information of the cell.

In various embodiments, the method 1000 further comprises transmitting association information for each SSB burst configuration of the plurality of SSB burst configurations with a random access configuration of a plurality of random access configurations, wherein communicating with the UE comprises receiving a random access preamble according to a random access configuration associated with the default SSB burst configuration. In one embodiment, communicating with the UE comprises transmitting a physical downlink channel signal, a physical downlink signal, or a combination thereof based on the default SSB burst configuration.

In certain embodiments, a first SSB burst configuration and a second SSB burst configuration of the plurality of SSB burst configurations comprise at least one SSB of a same SSB index transmitted with a same SSB periodicity. In some embodiments, the method 1000 further comprises transmitting information indicating a first scaling value and a second scaling value, wherein an effective transmit power of the at least one SSB of the same SSB index is computed by applying the first scaling value to a first SSB transmit power of the first SSB burst configuration and the second scaling value to a second SSB transmit power of the second SSB burst configuration.

In one embodiment, a method of a user equipment (UE) comprises: receiving a plurality of synchronization signal/physical broadcast channel block (“SSB”) burst configurations of a cell, wherein each SSB burst configuration of the plurality of SSB burst configurations comprises information indicating SSB positions in an SSB burst; and communicating with a network node of the cell based on a default SSB burst configuration, wherein the default SSB burst configuration is selected from the plurality of SSB burst configurations.

In certain embodiments, each SSB burst configuration of the plurality of SSB burst configurations further comprises an SSB periodicity.

In some embodiments, each SSB burst configuration of the plurality of SSB burst configurations further comprises an SSB transmit power value.

In various embodiments, the cell comprises a plurality of network nodes and each network node of the plurality of network nodes corresponds to an SSB burst configuration of the plurality of SSB burst configurations.

In one embodiment, the method further comprises receiving an indication indicating the default SSB burst configuration, wherein communicating with the network node comprises communicating with the network node based on the indicated default SSB burst configuration.

In certain embodiments, the indication indicating the default SSB burst configuration is received via a dedicated radio resource control (“RRC”) message or via a medium access control (“MAC”) control element (“CE”).

In some embodiments, the plurality of SSB burst configurations are received as a part of system information of the cell.

In various embodiments, the method further comprises receiving association information for each SSB burst configuration of the plurality of SSB burst configurations with a random access configuration of a plurality of random access configurations, wherein communicating with the network node comprises performing a random access procedure according to a random access configuration associated with the default SSB burst configuration.

In one embodiment, communicating with the network node comprises receiving a physical downlink channel signal, a physical downlink signal, or a combination thereof based on the default SSB burst configuration.

In certain embodiments, a first SSB burst configuration and a second SSB burst configuration of the plurality of SSB burst configurations comprise at least one SSB of a same SSB index transmitted with a same SSB periodicity.

In some embodiments, the method further comprises: receiving information indicating a first scaling value and a second scaling value; and computing an effective transmit power of the at least one SSB of the same SSB index by applying the first scaling value to a first SSB transmit power of the first SSB burst configuration and the second scaling value to a second SSB transmit power of the second SSB burst configuration.

In one embodiment, an apparatus comprises a user equipment (UE). The apparatus further comprises: a transceiver that: receives a plurality of synchronization signal/physical broadcast channel block (“SSB”) burst configurations of a cell, wherein each SSB burst configuration of the plurality of SSB burst configurations comprises information indicating SSB positions in an SSB burst; and communicates with a network node of the cell based on a default SSB burst configuration, wherein the default SSB burst configuration is selected from the plurality of SSB burst configurations.

In certain embodiments, each SSB burst configuration of the plurality of SSB burst configurations further comprises an SSB periodicity.

In some embodiments, each SSB burst configuration of the plurality of SSB burst configurations further comprises an SSB transmit power value.

In various embodiments, the cell comprises a plurality of network nodes and each network node of the plurality of network nodes corresponds to an SSB burst configuration of the plurality of SSB burst configurations.

In one embodiment, the transceiver receives an indication indicating the default SSB burst configuration, and communicating with the network node comprises communicating with the network node based on the indicated default SSB burst configuration.

In certain embodiments, the indication indicating the default SSB burst configuration is received via a dedicated radio resource control (“RRC”) message or via a medium access control (“MAC”) control element (“CE”).

In some embodiments, the plurality of SSB burst configurations are received as a part of system information of the cell.

In various embodiments, the transceiver receives association information for each SSB burst configuration of the plurality of SSB burst configurations with a random access configuration of a plurality of random access configurations, and communicating with the network node comprises performing a random access procedure according to a random access configuration associated with the default SSB burst configuration.

In one embodiment, communicating with the network node comprises receiving a physical downlink channel signal, a physical downlink signal, or a combination thereof based on the default SSB burst configuration.

In certain embodiments, a first SSB burst configuration and a second SSB burst configuration of the plurality of SSB burst configurations comprise at least one SSB of a same SSB index transmitted with a same SSB periodicity.

In some embodiments, the apparatus further comprises a processor, wherein: the transceiver receives information indicating a first scaling value and a second scaling value; and the processor computes an effective transmit power of the at least one SSB of the same SSB index by applying the first scaling value to a first SSB transmit power of the first SSB burst configuration and the second scaling value to a second SSB transmit power of the second SSB burst configuration.

In one embodiment, a method of a network device comprises: transmitting a plurality of synchronization signal/physical broadcast channel block (“SSB”) burst configurations of a cell, wherein each SSB burst configuration of the plurality of SSB burst configurations comprises information indicating SSB positions in an SSB burst; and communicating with a user equipment (“UE”) based on a default SSB burst configuration, wherein the default SSB burst configuration is selected from the plurality of SSB burst configurations.

In certain embodiments, each SSB burst configuration of the plurality of SSB burst configurations further comprises an SSB periodicity.

In some embodiments, each SSB burst configuration of the plurality of SSB burst configurations further comprises an SSB transmit power value.

In various embodiments, the cell comprises a plurality of network nodes and each network node of the plurality of network nodes corresponds to an SSB burst configuration of the plurality of SSB burst configurations.

In one embodiment, the method further comprises transmitting an indication indicating the default SSB burst configuration, wherein communicating with the UE comprises communicating with the UE based on the indicated default SSB burst configuration.

In certain embodiments, the indication indicating the default SSB burst configuration is transmitted via a dedicated radio resource control (“RRC”) message or via a medium access control (“MAC”) control element (“CE”).

In some embodiments, the plurality of SSB burst configurations are transmitted as a part of system information of the cell.

In various embodiments, the method further comprises transmitting association information for each SSB burst configuration of the plurality of SSB burst configurations with a random access configuration of a plurality of random access configurations, wherein communicating with the UE comprises receiving a random access preamble according to a random access configuration associated with the default SSB burst configuration.

In one embodiment, communicating with the UE comprises transmitting a physical downlink channel signal, a physical downlink signal, or a combination thereof based on the default SSB burst configuration.

In certain embodiments, a first SSB burst configuration and a second SSB burst configuration of the plurality of SSB burst configurations comprise at least one SSB of a same SSB index transmitted with a same SSB periodicity.

In some embodiments, the method further comprises transmitting information indicating a first scaling value and a second scaling value, wherein an effective transmit power of the at least one SSB of the same SSB index is computed by applying the first scaling value to a first SSB transmit power of the first SSB burst configuration and the second scaling value to a second SSB transmit power of the second SSB burst configuration.

In one embodiment, an apparatus comprises a network device. The apparatus further comprises: a transceiver that: transmits a plurality of synchronization signal/physical broadcast channel block (“SSB”) burst configurations of a cell, wherein each SSB burst configuration of the plurality of SSB burst configurations comprises information indicating SSB positions in an SSB burst; and communicates with a user equipment (“UE”) based on a default SSB burst configuration, wherein the default SSB burst configuration is selected from the plurality of SSB burst configurations.

In certain embodiments, each SSB burst configuration of the plurality of SSB burst configurations further comprises an SSB periodicity.

In some embodiments, each SSB burst configuration of the plurality of SSB burst configurations further comprises an SSB transmit power value.

In various embodiments, the cell comprises a plurality of network nodes and each network node of the plurality of network nodes corresponds to an SSB burst configuration of the plurality of SSB burst configurations.

In one embodiment, the transceiver transmits an indication indicating the default SSB burst configuration, and communicating with the UE comprises communicating with the UE based on the indicated default SSB burst configuration.

In certain embodiments, the indication indicating the default SSB burst configuration is transmitted via a dedicated radio resource control (“RRC”) message or via a medium access control (“MAC”) control element (“CE”).

In some embodiments, the plurality of SSB burst configurations are transmitted as a part of system information of the cell.

In various embodiments, the transceiver transmits association information for each SSB burst configuration of the plurality of SSB burst configurations with a random access configuration of a plurality of random access configurations, and communicating with the UE comprises receiving a random access preamble according to a random access configuration associated with the default SSB burst configuration.

In one embodiment, communicating with the UE comprises transmitting a physical downlink channel signal, a physical downlink signal, or a combination thereof based on the default SSB burst configuration.

In certain embodiments, a first SSB burst configuration and a second SSB burst configuration of the plurality of SSB burst configurations comprise at least one SSB of a same SSB index transmitted with a same SSB periodicity.

In some embodiments, the transceiver transmits information indicating a first scaling value and a second scaling value, wherein an effective transmit power of the at least one SSB of the same SSB index is computed by applying the first scaling value to a first SSB transmit power of the first SSB burst configuration and the second scaling value to a second SSB transmit power of the second SSB burst configuration.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method performed by a user equipment (UE), the method comprising:
receiving a plurality of synchronization signal/physical broadcast channel block (SSB) burst configurations of a cell, wherein each SSB burst configuration of the plurality of SSB burst configurations comprises information indicating SSB positions in an SSB burst; and
communicating with a network node of the cell based on a default SSB burst configuration, wherein the default SSB burst configuration is selected from the plurality of SSB burst configurations.

2. The method of claim 1, wherein each SSB burst configuration of the plurality of SSB burst configurations further comprises an SSB transmit power value.

3. A user equipment (UE), comprising:
at least one memory; and
at least one processor coupled with the at least one memory and configured to cause the UE to:
receive a plurality of synchronization signal/physical broadcast channel block (SSB) burst configurations of a cell, wherein each SSB burst configuration of the plurality of SSB burst configurations comprises information indicating SSB positions in an SSB burst; and
communicate with a network node of the cell based on a default SSB burst configuration, wherein the default SSB burst configuration is selected from the plurality of SSB burst configurations.

4. The UE of claim 3, wherein each SSB burst configuration of the plurality of SSB burst configurations further comprises an SSB periodicity.

5. The UE of claim 3, wherein each SSB burst configuration of the plurality of SSB burst configurations further comprises an SSB transmit power value.

6. The UE of claim 3, wherein the cell comprises a plurality of network nodes and each network node of the plurality of network nodes corresponds to an SSB burst configuration of the plurality of SSB burst configurations.

7. The UE of claim 3, wherein the at least one processor is configured to cause the UE to receive an indication indicating the default SSB burst configuration, and communicate with the network node based on the indicated default SSB burst configuration.

8. The UE of claim 7, wherein the indication indicating the default SSB burst configuration is received via a dedicated radio resource control (RRC) message or via a medium access control (MAC) control element (CE).

9. The UE of claim 3, wherein the plurality of SSB burst configurations are received as a part of system information of the cell.

10. The UE of claim 3, wherein the at least one processor is configured to cause the UE to receive association information for each SSB burst configuration of the plurality of SSB burst configurations with a random access configuration of a plurality of random access configurations, and perform a random access procedure according to a random access configuration associated with the default SSB burst configuration.

11. The UE of claim 3, wherein communicating with the network node comprises receiving a physical downlink channel signal, a physical downlink signal, or a combination thereof based on the default SSB burst configuration.

12. The UE of claim 3, wherein a first SSB burst configuration and a second SSB burst configuration of the plurality of SSB burst configurations comprise at least one SSB of a same SSB index transmitted with a same SSB periodicity.

13. The UE of claim 12, wherein:
the at least one processor is configured to cause the UE to receive information indicating a first scaling value and a second scaling value; and
the at least one processor is configured to cause the UE to compute an effective transmit power of the at least one SSB of the same SSB index by applying the first scaling value to a first SSB transmit power of the first SSB burst configuration and the second scaling value to a second SSB transmit power of the second SSB burst configuration.

14. An apparatus for performing a network function, the apparatus comprising:
at least one memory; and
at least one processor coupled with the at least one memory and configured to cause the apparatus to:
transmit a plurality of synchronization signal/physical broadcast channel block (SSB) burst configurations of a cell, wherein each SSB burst configuration of the plurality of SSB burst configurations comprises information indicating SSB positions in an SSB burst; and
communicate with a user equipment (UE) based on a default SSB burst configuration, wherein the default SSB burst configuration is selected from the plurality of SSB burst configurations.

15. The apparatus of claim 14, wherein each SSB burst configuration of the plurality of SSB burst configurations further comprises an SSB transmit power value.

16. A processor for wireless communication, comprising:
at least one controller coupled with at least one memory and configured to cause the processor to:
receive a plurality of synchronization signal/physical broadcast channel block (SSB) burst configurations of a cell, wherein each SSB burst configuration of the plurality of SSB burst configurations comprises information indicating SSB positions in an SSB burst; and
communicate with a network node of the cell based on a default SSB burst configuration, wherein the default SSB burst configuration is selected from the plurality of SSB burst configurations.

17. The processor of claim 16, wherein each SSB burst configuration of the plurality of SSB burst configurations further comprises an SSB periodicity.

18. The processor of claim 16, wherein each SSB burst configuration of the plurality of SSB burst configurations further comprises an SSB transmit power value.

19. The processor of claim 16, wherein the cell comprises a plurality of network nodes and each network node of the plurality of network nodes corresponds to an SSB burst configuration of the plurality of SSB burst configurations.

20. The processor of claim 16, wherein the at least one controller is configured to cause the processor to receive an indication indicating the default SSB burst configuration, and communicate with the network node based on the indicated default SSB burst configuration.
